(19) United States
(12) Patent Application Publication
(10) Pub. No.: US 2026/0184269 A1
(43) Pub. Date: Jul. 2, 2026

(54) METHOD FOR DYNAMICALLY CALIBRATING A DRIVER MONITORING SYSTEM

(71) Applicant: MiTAC Digital Technology Corporation, Taoyuan City (TW)

(72) Inventor: Yu-Sheng CHANG, Taoyuan City (TW)

(73) Assignee: MiTAC Digital Technology Corporation, Taoyuan City (TW)

(21) Appl. No.: 19/424,898

(22) Filed: Dec. 18, 2025

(30) Foreign Application Priority Data
Jan. 2, 2025 (TW) 114100162
Jul. 10, 2025 (TW) 114126128

(51) Int. Cl. B60R 11/04; G06V 10/75; G06V 20/59; G06V 40/16

(52) U.S. Cl. CPC B60R 11/04; G06V 10/758; G06V 20/59; G06V 40/165

(57) ABSTRACT

A method for dynamically calibrating a driver monitoring system (DMS) of a vehicle driven by a driver includes: generating standard image data based on a preset standard deviation (SD) threshold and an SD of a characteristic parameter that is related to a standard set of images of the driver obtained by the DMS; generating evaluation image data based on a predefined trigger event, the standard image data, and generating current image characteristic data that is related to a current set of images of the driver; calculating, based on the standard image data and the evaluation image data, a posture variation that is related to the driver; and determining, based on the posture variation and a variation threshold, whether to update the standard image data.

### CROSS-REFERENCE TO RELATED APPLICATION

This application claims priority to Taiwanese Invention patents application Nos. 114100162 and 114126128, filed respectively on Jan. 2, 2025 and Jul. 10, 2025, the entire disclosure of which is incorporated by reference herein.

### FIELD

The disclosure relates to a method for processing digital data, and more particularly to a method for dynamically calibrating a driver monitoring system of a vehicle for assisting a driver of the vehicle.

### BACKGROUND

In the field of automobile safety, determining whether a driver of a vehicle is paying attention is an important aspect.

As such, a driver monitoring system (DMS) installed in a vehicle may be used for implementing monitoring of a driver of the vehicle. A typical DMS may include an in-vehicle camera that is configured to capture images of the face of the driver, a processing unit, an alert unit, and a data storage unit.

The processing unit is configured to first process the images of the driver captured by the in-vehicle camera to obtain reference images indicating that the driver is concentrating, and to store the reference images in the data storage unit. Subsequently, while the vehicle is being driven, the DMS is activated, and the processing unit is configured to process and compare the images currently captured by the in-vehicle camera with the reference images, so as to determine whether the driver is concentrating. In a case where the driver is determined as being not concentrating (e.g., the images currently captured by the in-vehicle camera shows that, the driver has been turning his/her head for longer than a threshold time period, is in a fatigued state, is using a cellphone, etc.), the processing unit may control the alert unit to output an alert (e.g., a sound alert) to notify the driver.

It is noted that the criteria used for determine whether the driver is not concentrating are typically uniform across all DMSs. However, due to different personal driving habits, different drivers may perform similar movements, but not all of them are not concentrating. For example, a driver may have been turning his/her head for longer than the threshold time period when reversing or turning the vehicle; as a result, the detection of the DMS may be inaccurate, which results in false alerts. In some cases, some drivers may be driving the vehicles using some specific body gestures which may be erroneously determined as being not concentrating, and therefore the processing unit may continuously control the alert unit to output the alert, which ironically may actually disturb the drivers and cause inconveniences.

### SUMMARY

It may be desirable for the DMS to be able to determine, in response to a driver being in a changed body pose that differs from a standard body pose, whether the vehicle is still being driven normally, and in a case where the determination is affirmative, a set of criteria, which is used for determining whether the driver is not concentrating, is adjusted, so as to alleviate at least one drawback of the prior art.

According to one embodiment of the disclosure, a method for dynamically calibrating a driver monitoring system (DMS) of a vehicle driven by a driver is provided. The method is implemented by the DMS which is configured to continuously capture images of the driver. The method includes the following steps of:
generating standard image data based on a preset standard deviation (SD) threshold and an SD of a characteristic parameter that is related to a candidate set of images of the driver obtained by the DMS;
generating evaluation image data based on a predefined trigger event, the standard image data, and current image characteristic data that is related to a current set of images of the driver currently obtained by the DMS;
calculating, based on the standard image data and the evaluation image data, a posture variation that is related to a posture of the driver; and
determining, based on the posture variation and a variation threshold, whether to update the standard image data.

According to another embodiment of the disclosure, a method for dynamically calibrating a driver monitoring system (DMS) of a vehicle driven by a driver is provided. The method is implemented by the DMS which repeatedly obtaining images of the driver. The method includes the following steps of:
generating standard image data based on a preset standard deviation (SD) threshold and an SD of a characteristic parameter that is related to a standard set of images of the driver obtained by the DMS;
making a comparison between the standard image data and current image characteristic data that is related to a current set of images of the driver obtained by the DMS;
determining, based on a result of the comparison thus made, whether a predefined trigger event occurs;
in response to determining that the predefined trigger event occurs, outputting an alert, generating evaluation image data based on a part of the current image characteristic data that is related to occurrence of the predefined trigger event;
calculating, based on the standard image data and the evaluation image data, a posture variation that is related to the driver; and
determining, based on the posture variation and a variation threshold, whether to update the standard image data;
in response to determining to update the standard image data,
designating a sequence of images of the driver currently obtained by the DMS as candidate set of images,
for each candidate image in the candidate set of images, obtaining, by using an image recognition model based on the candidate image, a set of characteristic parameters that is related to a face of the driver in the candidate image,
generating, based on the sets of characteristic parameters obtained from the candidate set of images, candidate image data that contains a set of SD values related to the sets of characteristic parameters, and
performing, based on the set of SD values contained in the candidate image data, the preset SD threshold, a current speed of the vehicle and a preset speed threshold, a standard-image test on the candidate image data, and
in response to determining that the candidate image data has passed the standard-image test, designating the candidate image data as the standard image data and storing the standard image data.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a driver monitoring system (DMS) according to an embodiment of the disclosure.

FIG. 2 is a flow chart of a method for dynamically calibrating the DMS according to an embodiment of the disclosure.

FIG. 3 is a flow chart illustrating sub-steps of the operations of calculating a posture variation according to an embodiment of the disclosure.

FIG. 4 is a flow chart of a method for dynamically calibrating the DMS according to another embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

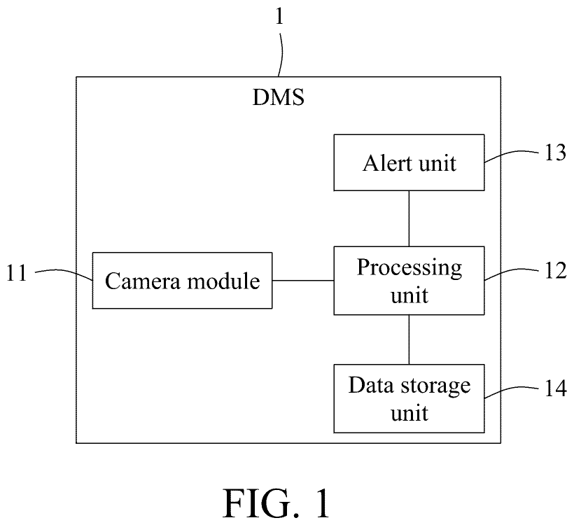

FIG. 1 is a block diagram of a driver monitoring system (DMS) 1 according to one embodiment of the disclosure. In the embodiment of FIG. 1, the DMS 1 may be installed in a vehicle (not shown) and includes a camera module 11, a processing unit 12, an alert unit 13, and a data storage unit 14.

The camera module 11 includes an in-vehicle camera disposed to capture images of a driver of the vehicle, and may include additional cameras for capturing images of the surrounding of the vehicle.

The processing unit 12 is connected to the camera module 11, and may include one or more of a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), a system on chip (SoC), a radio-frequency integrated circuit (RFIC), etc.

The alert unit 13 is connected to the processing unit 12, and may be controlled by the processing unit 12 to generate and output an alert (e.g., an audible and/or a visual alert) to notify the driver of the vehicle.

The data storage unit 14 is connected to the processing unit 12, and may be embodied using, for example, random access memory (RAM), read only memory (ROM), programmable ROM (PROM), firmware, flash memory, or other suitable non-transitory storage media. The data storage unit 14 stores a software application therein. The software application includes instructions that, when executed by the processing unit 12, cause the processing unit 12 to implement the operations as described below.

The data storage unit 14 further includes an image recognition model that may be embodied using commercially available neural networks such as You Only Look Once (YOLO) 4, a convolutional neural network (CNN), a region-based convolutional neural networks (R-CNN), and that is configured to implement a facial landmark detection on images containing a human body. Generally, the image recognition model is capable of comparing different images that contain a human body and that are captured successively, and determining a motion of the human body based on the comparison. It is noted that in some embodiments, since the computational capability of the DMS 1 is typically relatively limited, suitable lightweight model may be employed such as YOLOv9, MediaPipe Face Mesh, Open pose, etc. It is noted that the above operations related to the image recognition model are well known in the related art, and therefore the details thereof are omitted herein for the sale of brevity.

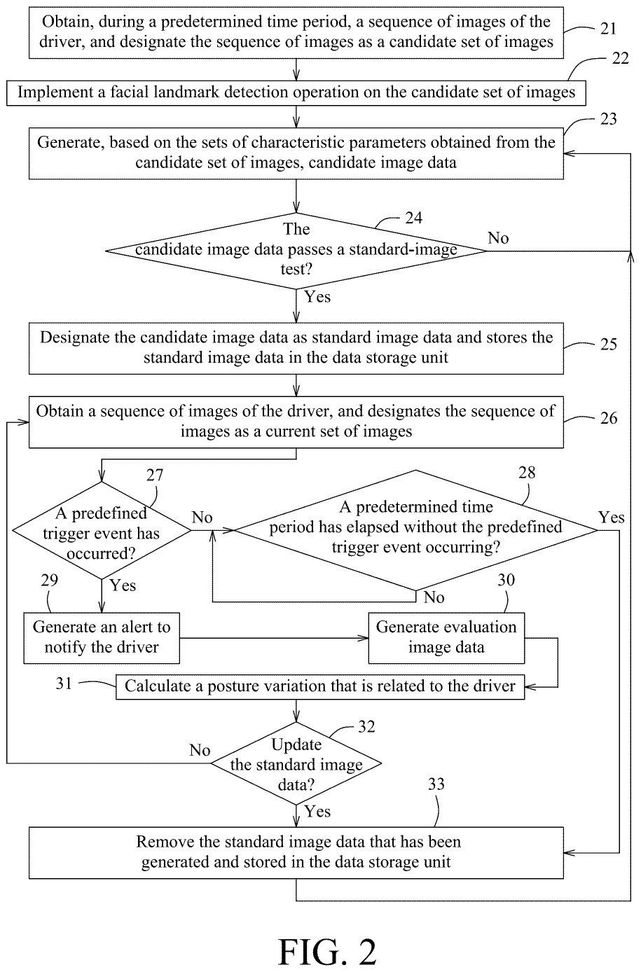

FIG. 2 is a flow chart illustrating steps of a method for dynamically calibrating a DMS according to one embodiment of the disclosure. In the embodiment of FIG. 2, the method is implemented by the DMS 1 of FIG. 1. The method includes a standard image data generation process (steps 21-25) and an evaluation image data generation process (steps 26-33).

During use, the DMS 1 is configured to first implement the standard image data generation process to first generate standard image data for a specific driver.

In step 21, while the vehicle is being driven, the camera module 11 is activated to continuously capture images of the driver, and the processing unit 12 obtains, during a predetermined time period (e.g., 15 seconds), a sequence of images of the driver, and designates the sequence of images as a candidate set of images. In some embodiments, the sequence of images may include a predetermined number of images (e.g., 100 images). Each image (frame) of the sequence of images is digital data composed of a plurality of pixels arranged in a matrix for subsequent processing, and each of the plurality of pixels may be represented by a set of RGB values of a specific color that corresponds to a specific part of the image (scene) in the real environment.

Then, in step 22, the processing unit 12 executes the image recognition model stored in the data storage unit 14, in order to implement the facial landmark detection on the candidate set of images. Specifically, for each candidate image of the candidate set of images, the processing unit 12 implements the facial landmark detection on the candidate image to obtain a set of characteristic parameters that is related to the face of the driver in the candidate image. Therefore, in a case where the sequence of images includes 100 images, 100 sets of characteristic parameters may be obtained.

Specifically, in some embodiments, the facial landmark detection is able to obtain a plurality of facial landmarks that cooperatively define eyebrows, eyes, the nose, lips and the contour of the face of the driver. During use, a commercially available image recognition model that is suitable for implementing the facial landmark detection may be employed.

Using the facial landmarks detected in each candidate image of the candidate set of images, multiple sets of two-dimensional (2D) coordinates respectively of the facial landmarks, parameters related to movement of the face (including a value of pitch, a value of yaw, and a value of roll of the face) which is related to movement of the head and the changes of posture of the driver, and an area of the face included in the candidate image may be calculated to serve as the set of characteristic parameters. In some embodiments, each set of characteristic parameters may further include a set of 2D coordinates indicating a location of the nose of the driver and/or a set of 2D coordinates indicating a location of a center of the face of the driver. It is noted that the operations of detecting the movement of the head and the changes of the driver's posture using the facial landmarks detected from variations in pixel clusters across successive images are readily known in the prior art, and details thereof are omitted herein for the sake of brevity.

In some embodiments, since the face of the driver may have movements due to different causes such as a change of a posture (which may involve movements of the shoulders and/or the torso of the user), those causes may result in the face of the driver included in the images captured by the camera module 11 changing (e.g., shifting, swinging or tilting), and therefore an area of the face in the images may also change over time (e.g., in some cases, parts of the shoulders and torso may be captured). Additional factors may also affect the content in the images captured by the camera module 11, such as a location of the camera module 11, dimensions of different vehicles, seat arrangement of different drivers, etc. As such, in some embodiments, the processing unit 12 further determines whether the candidate set of images fully contain the entire face of the driver, and in a case where it is determined that the entire face of the driver is not fully contained in the candidate set of images, specific procedures may be implemented, or the candidate set of images may be discarded. In some examples, due to different reasons such as the movement of the driver within the vehicle, the driver adjusting a driver's seat, the body parts of the drivers contained in the images captured may frequently change and the resulting images contain different body parts of the driver. For example, in the case that the driver's seat is moved forward, the shoulders and torso of the driver may be missing in the images and cannot be consistently included in the images. In such cases, considering that the face of the driver is most likely to be completely captured, the method in some embodiments places the focus on the facial landmarks in different images for determining whether the driver is distracted.

Then, in step 23, the processing unit 12 generates, based on the sets of characteristic parameters obtained from the candidate set of images, candidate image data. In some embodiments, the candidate image data contains a set of average values and a set of standard deviation (SD) values related to the sets of characteristic parameters.

Specifically, using the predetermined number of the sets of characteristic parameters, an average of the values of pitch respectively in the predetermined number of the sets of characteristic parameters, an average of the values of yaw respectively in the predetermined number of the sets of characteristic parameters, and an average of the values of roll respectively in the predetermined number of the sets of characteristic parameters may be calculated to serve as the set of average values. Additionally, using the predetermined number of the sets of characteristic parameters, an SD of the values of pitch, and an SD of the values of yaw and an SD of the values of roll may be calculated to serve as the set of SD values.

Then, in step 24, the processing unit 12 performs a standard-image test on the candidate image data, in order to determine whether the driver remains in a stable pose long enough (i.e., for the predetermined time period), and to determine whether the vehicle is indeed being driven.

In some embodiments, the standard-image test is performed based on the set of average values and the set of SD values contained in the candidate image data, a preset SD threshold, a current speed of the vehicle and a preset speed threshold.

Specifically, in some embodiments, each of the SD values (pitch, yaw and roll) in the set of SD values is compared with the preset SD threshold. In a case where any one of the SD values is greater than the preset SD threshold, the processing unit 12 may determine that the standard-image test fails, as the driver is moving too erratically and is not in a stable pose.

In addition, the current speed of the vehicle may be recorded by a global positioning system (GPS) device or a speedometer installed in the vehicle. In a case where the current speed of the vehicle remains higher than the preset speed threshold (e.g., 30 kilometers per hour) during the predetermined time period, the processing unit 12 may determine that the vehicle is being driven during the predetermined time period. In some embodiments, the processing unit 12 may be further connected to an accelerometer (installed on the vehicle or from a mobile electronic device) to receive a G-force value related to an acceleration of the vehicle from the accelerometer. In a case where the G-force value remains lower than a preset G-force value threshold (e.g., 0.15G) during the predetermined time period, the processing unit 12 may determine that the vehicle is being driven stably during the predetermined time period. On the other hand, in a case where the current speed of the vehicle does not remain higher than the preset speed threshold during the predetermined time period, or where the G-force value is higher than the preset G-force value threshold during the predetermined time period, the processing unit 12 may determine that the vehicle is not being driven stably during the predetermined time period.

In a case where the candidate image data indicates that the driver remains in a stable pose and the vehicle is being driven stably, the processing unit 12 determines that the candidate image data passes the standard-image test, and the flow proceeds to step 25. Otherwise, in a case where the candidate image data indicates that the driver does not remain in a stable pose or the vehicle is not being driven stably, the processing unit 12 determines that the candidate image data fails the standard-image test, and the flow goes back to step 23, in which the processing unit 12 obtains a new sequence of images of the driver, and designates the new sequence of images as a new candidate set of images. Then, the processing unit 12 repeats steps 23 and 24 to re-generate the candidate image data and perform the standard-image test on the candidate image data thus re-generated until the candidate image data currently generated passes the standard-image test.

In step 25, the processing unit 12 designates the candidate image data as the standard image data for the driver, and stores the standard image data in the data storage unit 14. As such, the standard image data generation process is completed.

After the standard image data has been stored, during use, the DMS 1 is configured to implement the evaluation image data generation process (steps 26-33).

In step 26, while the vehicle is being driven, the camera module 11 is activated to continuously capture images of the driver, and the processing unit 12 obtains, during another predetermined time period (e.g., 15 seconds), a sequence of images of the driver, and designates the sequence of images as a current set of images currently obtained by the processing unit 12.

In step 27, the processing unit 12 processes the current set of images, so as to determine whether a predefined trigger event occurs during the another predetermined time period. In a case where it is determined that predefined trigger event occurs during the another predetermined time period, the flow proceeds to step 29. Otherwise, in a case where it is determined that predefined trigger event does not occur during the another predetermined time period, the flow proceeds to step 28.

In the embodiment of FIG. 2, the operations of step 27 include the processing unit 12 generating current image characteristic data that is related to the current set of images of the driver. The current image characteristic data may include information related to the facial landmarks of the driver in each of the images of the current set of images. Then, the processing unit 12 processes the current image characteristic data and compares the current image characteristic data with the standard image data to determine whether the predefined trigger event occurs. For example, the predefined trigger event may be one of the driver being distracted, the driver being fatigued, or the driver using a mobile electronic device. During use, the driver is determined to be distracted when the face of the driver indicated by the current image characteristic data is turned more than a threshold (e.g., 20 degrees) with respect to the standard image data, the driver is determined to be fatigued when the face of the driver indicated by the current image characteristic data inclines downwards or is nodding (indicated by repeated vertical movement of the face), and the driver is determined to be using a mobile electronic device when a hand of the driver holding the mobile electronic device is detected in the current set of images. It is noted that in some embodiments, other standards may be employed to implement the determination.

In step 28, the processing unit 12 determines whether a predetermined time period has elapsed without the predefined trigger event occurring. In a case where it is determined that the predetermined time period has not yet elapsed, the flow goes back to step 27. Otherwise, the flow proceeds to step 33.

In step 29, the processing unit 12 controls the alert unit 13 to output an alert to notify the driver. During use, the alert may include an audio warning and/or a visual warning.

Then, in step 30, the processing unit 12 generates evaluation image data based on a part of the current image characteristic data that is related to occurrence of the predefined trigger event.

Specifically, in some embodiments, the evaluation image data may be generated by extracting a part of the current image characteristic data associated with images captured in the time instances near the occurrence of the predefined trigger event (e.g., from an evaluation time period that starts prior to the occurrence of the predefined trigger event and that ends after the occurrence of the predefined trigger event) to serve as the evaluation image data.

In step 31, the processing unit 12 calculates, based on the standard image data and the evaluation image data, a posture variation that is related to the posture of the driver. Specifically, the posture variation indicates how much the posture of the driver during the evaluation time period differs from the posture of the driver as indicated by the standard image data.

It is noted that in some embodiments, in order to facilitate the operations, the calculation of the posture variation may be initiated after the standard image data is generated. That is to say, after a standard posture of the driver has been established, the calculation of the posture variation can be executed in the background concurrently.

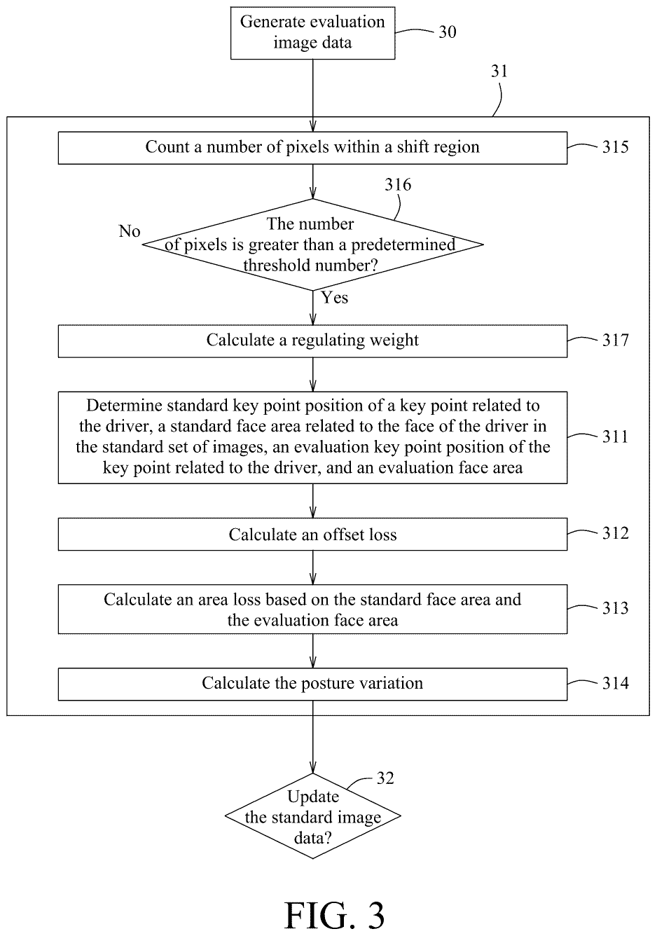

FIG. 3 is a flow chart illustrating sub-steps of the operations of step 31 according to an embodiment of the disclosure.

In sub-step 311, the processing unit 12 determines, based on the standard image data, a standard key point position of a key point related to the driver (which may be the nose and/or the center of the face), a standard face area related to the face of the driver in the candidate set of images that are last obtained in step 21 and that are used to generate the standard image data, an evaluation key point position of the key point related to the driver, and an evaluation face area related to the face of the driver in the current set of images.

In the embodiment of FIG. 3, the standard key point position may be represented using the set of 2D coordinates (C₁ₓ, C_{1y}) indicating the location of the nose of the driver, the standard face area may be represented by a product of a width and a height of the face (w1*h1) (which may be determined by counting the number of pixels constituting the face), the evaluation key point position may be represented using the set of 2D coordinates (C₂ₓ, C_{2y}) indicating the location of the nose of the driver, and the evaluation face area may be represented by a product of a width and a height of the face (w2*h2).

In sub-step 312, the processing unit 12 calculates an offset loss based on the standard key point position, the evaluation key point position, the standard face area and the evaluation face area. The offset loss indicates how much the key point is shifted from the standard key point position to the evaluation key point position.

In the embodiment of FIG. 3, the offset loss may be calculated using the following equations:

$$Offset loss = ( L / {L}_{max} )$$

$$L = \sqrt{[ {( {C}_{1 x} - {C}_{2 x} )}^{2} + {( {C}_{1 y} - {C}_{2 y} )}^{2} ]} , and$$

$${L}_{max} = \sqrt{[ {max ( w 1 , w 2 )}^{2} + max ( h 1 , h 2 ) ]} .$$

It is noted that in some embodiments, the change of evaluation face area may be calculated using multiple images associated with the evaluation image data. Since the calculations may be done without data other than the standard image data and the evaluation image data, the operations of such calculations may be done more efficiently.

In sub-step 313, the processing unit 12 calculates an area loss based on the standard face area and the evaluation face area. The area loss indicates how much the area of the face is shifted from the standard face area to the evaluation face area.

In the embodiment of FIG. 3, the area loss may be calculated using the following equation:

$$Area loss = \vert w 1 * h 1 - w 2 * h 2 \vert \div max ( w 1 * h 1 , w 2 * h 2 ) .$$

Then, in sub-step 314, the processing unit 12 calculates the posture variation based on an offset weight (weightₒ), the offset loss, an area weight (weight_{A}) and the area loss.

In the embodiment of FIG. 3, the posture variation may be calculated using the following equation:

$$Posture variation = {weight}_{A} * area lose + {weight}_{O} * offset loss .$$

It is noted that in some embodiments, both the offset loss and the area loss may be used for evaluating the posture variation. However, in some cases, one or both of the factors (the offset loss and the area loss) may be affected by other factors. As such, in order to obtain a more accurate posture variation, combining both factors with a combination of weights may be employed. For example, in some cases where the vehicle is dimly lit, the position of the key point may be difficult to calculate. Therefore, by combining the area loss with and the offset loss in the calculation using different weights, the posture variation may be then calculated with more accuracy. In different embodiments, based on the habits of different drivers, different combinations of the offset weight and the area weight may be employed. For example, for drivers who are considered as more prone to move their heads horizontally, the offset weight may be adjusted higher while the area weight may be adjusted lower. In some embodiments, each of the offset weight and the area weight is a variable, and a sum of the offset weight and the area weight is not less than one.

It is noted that the above calculations only involve calculating a weighted sum, which can be implemented without requiring much calculation capacity, and may be done using devices with relatively less calculation capacity.

It is noted that in some embodiments, prior to the implementation of sub-step 311, there are a number of sub-steps for determining whether the content of the standard image data and the content of the evaluation image data significantly differ from each other. For example, in one case, the standard image data includes images that cover the face of the driver, and the evaluation image data includes images that cover not only the face of the driver but also the shoulders and parts of the torso of the driver. In such cases, it may be determined that the scales of the face in the standard image data and the evaluation image data are different, and therefore additional adjustment (sub-steps 315-317) may be needed.

In sub-step 315, the processing unit 12 counts, based on the standard image data and the evaluation image data, a second number of pixels within a shift region that is related to the driver in the candidate set of images with respect to the standard image data. In some embodiments, the second number of pixels may be counted with respect to one of the images of the candidate set of images, or may be counted with respect to multiple images of the candidate set of images and an average number of pixels may be calculated to serve as the second number of pixels.

In sub-step 316, the processing unit 12 determines whether the second number of pixels is greater than a predetermined threshold (e.g., the first number of pixels). In a case where the second number of pixels is not greater than the predetermined threshold, the flow proceeds to step 311 as no adjustment is needed. Otherwise, in a case where the second number of pixels is greater than the predetermined threshold, the flow proceeds to sub-step 317.

In sub-step 317, in response to determining that the second number of pixels is greater than the predetermined threshold, the processing unit 12 calculates a regulating weight based on the standard image data and the evaluation image data. For example, the regulating weight may be calculated by calculating a ratio of the second number of pixels to the first number of pixels.

Afterwards, in sub-step 311, the processing unit 12 determines the standard key point position and the standard face area further by adjusting the standard key point position and the standard face area based on the regulating weight. As such, the potential error due to the scales of the face in the standard image data and the evaluation image data being different may be mitigated.

In step 32, the processing unit 12 determines, based on the posture variation and a variation threshold, whether to update the standard image data stored in the data storage unit 14. Specifically, the processing unit 12 determines whether the posture variation is greater than the variation threshold. In a case where it is determined that the posture variation is greater than the variation threshold, the flow proceeds to step 33. Otherwise, in a case where it is determined that the posture variation is not greater than the variation threshold, the flow goes back to step 26 to continue processing the subsequent current set of images.

In step 33, the processing unit 12 removes the standard image data that are currently stored in the data storage unit 14. Then, the flow goes back to step 21, so as to generate and store another standard image data in the data storage unit 14. It is noted that in the case of step 28, in which no predetermined trigger event occurs during the predetermined time period, the flow also proceeds to step 33 to update the standard image data based on a current posture of the driver, and the operations of steps 22 to 27 may be repeated to form a loop. That is to say, the processing unit 12 generates another current image characteristic data that is related to another current set of images of the driver, and determines whether the predefined trigger event occurs based on the another current image characteristic data and the another standard image data.

As such, the sudden movement of the driver may be easily detected by the DMS 1.

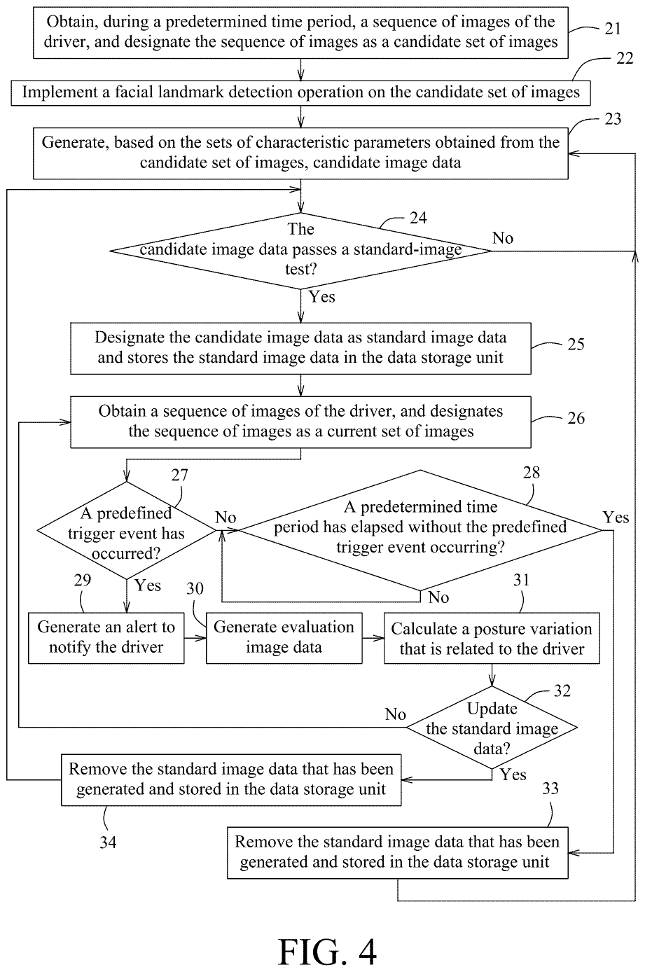

FIG. 4 is a flow chart of a method for dynamically calibrating the DMS 1 according to one embodiment of the disclosure. In the embodiment of FIG. 4, the method is implemented by the DMS 1 of FIG. 1.

The main difference between the embodiments of FIG. 2 and FIG. 4 is that, if the determination of step 32 is affirmative, the flow proceeds to step 34, in which the processing unit 12 removes the standard image data that are currently stored in the data storage unit 14. Then, the flow goes back to step 24. Specifically, in some cases, although it is detected that the posture of the driver has moved, but the posture has remained steady and the driver is otherwise not deemed as distracted or fatigued, the DMS 1 may also use the detected pose to establish the standard image data. As such, as long as the driver remains in the same pose, the potential false alerts due to unsuitable standards may be eliminated.

To sum up, embodiments of the disclosure provide a method for dynamically calibrating a driver monitoring system (DMS) of a vehicle for assisting a driver of the vehicle. In the method, standard image data based on the images of the driver in a stable pose while the vehicle is being driven is first generated and stored. Then, the DMS generates the evaluation image data based on a predefined trigger event, the standard image data, and the current image characteristic data that is related to a current set of images of the drive. Then, the DMS calculates, based on the standard image data and the evaluation image data, the posture variation that is related to the posture of the driver; and determines, based on the posture variation and a variation threshold, whether to update the standard image data. Using the method as described above, the standard image data may be dynamically updated and is customized for different drivers, and the potential false alerts due to inadequate calibration reference (standard image data) may be reduced. Additionally, in a case where the DMS detects a predefined trigger event (e.g., one of the driver being distracted, the driver being fatigued, and the driver using a mobile electronic device), the DMS still outputs an alert regardless of the posture of the driver. As such, the DMS is still capable of continuously alerting the driver until the predefined trigger event is no longer detected.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for dynamically calibrating a driver monitoring system (DMS) of a vehicle driven by a driver, the method being implemented by the DMS, the DMS being configured to continuously capture images of the driver, the method comprising steps of:
generating standard image data based on a preset standard deviation (SD) threshold and an SD of a characteristic parameter that is related to a candidate set of images of the driver obtained by the DMS;
generating evaluation image data based on a predefined trigger event, the standard image data, and current image characteristic data that is related to a current set of images of the driver currently obtained by the DMS;
calculating, based on the standard image data and the evaluation image data, a posture variation that is related to a posture of the driver; and
determining, based on the posture variation and a variation threshold, whether to update the standard image data.

2. The method as claimed in claim 1, wherein the step of generating standard image data includes sub-steps of:
designating a sequence of images of the driver currently obtained by the DMS as the candidate set of images;
for each candidate image in the candidate set of images, obtaining, by using an image recognition model based on the candidate image, a set of characteristic parameters that is related to a face of the driver in the candidate image;
generating, based on the sets of characteristic parameters obtained from the candidate set of images, candidate image data that contains a set of SD values related to the sets of characteristic parameters;
performing, based on the set of SD values contained in the candidate image data, the preset SD threshold, a current speed of the vehicle and a preset speed threshold, a standard-image test on the candidate image data, the standard-image test including
determining whether each SD value in the set of SD values of the characteristic parameter contained in the candidate image data is less than the preset SD threshold, and
determining whether the current speed of the vehicle is not less than the preset speed threshold; and
in response to determining that the candidate image data has passed the standard-image test, designating the candidate image data as the standard image data and storing the standard image data.

3. The method as claimed in claim 2, wherein the step of calculating a posture variation includes sub-steps of:
determining, based on the standard image data, a standard key point position of a key point related to the driver and a standard face area related to the face of the driver in the candidate set of images;
determining, based on the evaluation image data, an evaluation key point position of the key point related to the driver and an evaluation face area related to the face of the driver in the current set of images;
calculating an offset loss based on the standard key point position, the evaluation key point position, the standard face area and the evaluation face area;
calculating an area loss based on the standard face area and the evaluation face area; and
calculating the posture variation based on an offset weight, the offset loss, an area weight and the area loss.

4. The method as claimed in claim 3, wherein each of the offset weight and the area weight is a variable, and a sum of the offset weight and the area weight is not less than one.

5. The method as claimed in claim 3, wherein the step of calculating a posture variation further includes sub-steps of, prior to determining the standard key point position and the standard face area:
counting, based on the standard image data, a first number of pixels within a region that is related to the driver in the candidate set of images;
counting, based on the evaluation image data, a second number of pixels within a region that is related to the driver in the current set of images;
determining whether the second number of pixels is greater than the first number of pixels; and
in response to determining that the second number of pixels is greater than the first number of pixels, calculating a ratio of the second number of pixels to the first number of pixels as a regulating weight,
wherein determining the standard key point position and the standard face area includes adjusting the standard key point position of the key point and the standard face area based on the regulating weight.

6. The method as claimed in claim 1, wherein the step of generating standard image data includes sub-steps of:
designating a sequence of images of the driver obtained by the DMS as the candidate set of images;
for each candidate image in the candidate set of images, obtaining, by using an image recognition model based on the candidate image, a set of characteristic parameters that is related to the face of the driver in the candidate image;
generating, based on the sets of characteristic parameters obtained from the candidate set of images, candidate image data that contains a set of SD values related to the sets of characteristic parameters;
performing, based on the set of SD values in the candidate image data, the preset SD threshold, a current g-force of the vehicle and a g-force threshold, a standard-image test that includes
determining whether each SD value in the set of SD values contained in an entry of candidate image data is less than the preset SD threshold, and
determining whether the current g-force of the vehicle is less than the g-force threshold; and
in response to determining that the candidate image data has passed the standard-image test, designating the candidate image data as the standard image data and storing the standard image data.

7. The method as claimed in claim 6, further comprising steps of, in response to determining that the candidate image data has failed the standard-image test:
re-generating the candidate image data and performing the standard-image test on the candidate image data thus re-generated; and
in response to determining that the candidate image data thus re-generated has passed the standard-image test, designating the candidate image data thus re-generated as the standard image data and storing the standard image data thus re-generated.

8. The method as claimed in claim 1, wherein the step of generating evaluation image data includes sub-steps of:
designating a sequence of images of the driver obtained by the DMS as the current set of images;
generating current image characteristic data based on the current set of images;
making a comparison between the current image characteristic data and the standard image data;
determining, based on a result of the comparison thus made, whether the predefined trigger event occurs; and
in response to determining that the predefined trigger event occurs,
outputting an alert, and
generating the evaluation image data based on a part of the current image characteristic data that is related to occurrence of the predefined trigger event.

9. The method as claimed in claim 8, wherein the step of generating evaluation image data further includes sub-steps of:
in response to determining that the predefined trigger event does not occur, after a predetermined time period has elapsed, removing the standard image data that has been generated and stored, and repeating the step of generating standard image data, so as to generate another standard image data.

10. The method as claimed in claim 9, further comprising:
generating another current image characteristic data that is related to another current set of images of the driver; and
determining whether the predefined trigger event occurs based on the another current image characteristic data and the another standard image data.

11. The method as claimed in claim 8, wherein the step of determining whether to update the standard image data is to determine whether the posture variation is greater than the variation threshold, and the method further comprising a step of:
in response to determining that the posture variation is not greater than the variation threshold, repeating the sub-steps of designating the current set of images, generating the current image characteristic data, making a comparison between the current image characteristic data and the standard image data, and determining whether the predefined trigger event occurs.

12. The method as claimed in claim 1, wherein the step of determining whether to update the standard image data is to determine whether the posture variation is greater than the variation threshold, and the method further comprising a step of:
in response to determining that the posture variation is greater than the variation threshold, removing the standard image data that has been generated and stored, and repeating the step of generating standard image data so as to generate another standard image data.

13. The method as claimed in claim 12, further comprising:
generating another current image characteristic data that is related to another current set of images of the driver; and
determining whether the predefined trigger event occurs based on the another current image characteristic data and the another standard image data.

14. A method for dynamically calibrating a driver monitoring system (DMS) of a vehicle driven by a driver, the method being implemented by the DMS, the DMS repeatedly obtaining images of the driver, the method comprising steps of:
generating standard image data based on a preset standard deviation (SD) threshold and an SD of a characteristic parameter that is related to a standard set of images of the driver obtained by the DMS;
making a comparison between the standard image data and current image characteristic data that is related to a current set of images of the driver obtained by the DMS;
determining, based on a result of the comparison thus made, whether a predefined trigger event occurs;
in response to determining that the predefined trigger event occurs,
outputting an alert,
generating evaluation image data based on a part of the current image characteristic data that is related to occurrence of the predefined trigger event;
calculating, based on the standard image data and the evaluation image data, a posture variation that is related to the driver; and
determining, based on the posture variation and a variation threshold, whether to update the standard image data;
in response to determining to update the standard image data,
designating a sequence of images of the driver currently obtained by the DMS as candidate set of images,
for each candidate image in the candidate set of images, obtaining, by using an image recognition model based on the candidate image, a set of characteristic parameters that is related to a face of the driver in the candidate image,
generating, based on the sets of characteristic parameters obtained from the candidate set of images, candidate image data that contains a set of SD values related to the sets of characteristic parameters, and
performing, based on the set of SD values contained in the candidate image data, the preset SD threshold, a current speed of the vehicle and a preset speed threshold, a standard-image test on the candidate image data, and
in response to determining that the candidate image data has passed the standard-image test, designating the candidate image data as the standard image data and storing the standard image data.

15. The method as claimed in claim 14, wherein the step of calculating a posture variation includes sub-steps of:
determining, based on the standard image data, a standard key point position of a key point related to the driver and a standard face area related to the face of the driver in the candidate set of images;
determining, based on the evaluation image data, an evaluation key point position of the key point related to the driver and an evaluation face area related to the face of the driver in the current set of images;
calculating an offset loss based on the standard key point position, the evaluation key point position, the standard face area and the evaluation face area;
calculating an area loss based on the standard face area and the evaluation face area; and
calculating the posture variation based on an offset weight, the offset loss, an area weight and the area loss.

16. The method as claimed in claim 15, wherein each of the offset weight and the area weight is a variable, and a sum of the offset weight and the area weight is not less than one.
